(19) United States
(12) Patent Application Publication
(10) Pub. No.: US 2025/0226600 A1
(43) Pub. Date: Jul. 10, 2025

(54) CONNECTOR SUB-ASSEMBLY OR CONNECTOR FOR A CABLE WITH AT LEAST ONE INSULATED ELECTRICAL WIRE, COMPRISING A METAL BODY HOUSING AT LEAST ONE CENTRAL CONTACT CONNECTED TO A CABLE WIRE AND COMPRISING A REAR PART FOR CRIMPING AROUND A FERRULE FOR CRIMPING ONTO THE CABLE

(71) Applicant: RAYDIALL, Voiron (FR)

(72) Inventors: Sébastien ANNEQUIN, Saint Nicolas de Macherin (FR); Denis Gabet, Colombe (FR)

(21) Appl. No.: 19/009,112

(22) Filed: Jan. 3, 2025

(30) Foreign Application Priority Data
Jan. 8, 2024 (FR) 2400161

(51) Int. Cl. H01R 9/05; H01R 43/05

(52) U.S. Cl. CPC H01R 9/0518; H01R 43/05

(57) ABSTRACT

Connector sub-assembly or connector for a cable with at least one insulated electrical wire, including a metal body housing at least one central contact connected to a cable wire and comprising a rear part for crimping around a ferrule for crimping onto the cable. The invention relates to a connector sub-assembly or connector, intended to be electrically connected to an electrical cable including at least one insulated wire including a core and an electrically insulating sheath, a metal braid encircling the at least one insulated wire, and an outer sheath made of electrically insulating material encircling the metal braid. The sub-assembly includes a ferrule crimped first to the metal braid of the cable in a configuration permitting rear axial abutment against the outer sheath of the cable.

### TECHNICAL FIELD

The present invention relates to the field of electrical and/or data-transmission connections.

It more particularly relates to a connector each central contact of which is connected, and preferably crimped, to a stripped end of an electrical cable wire.

The invention is in particular applicable to data-transmission connections using cables comprising one, a pair or a plurality of pairs of shielded or unshielded transmission wires.

The invention is more generally applicable to any type of connection for transmitting electrical signals and/or data and/or radio-frequency (RF) signals, including coaxial connectors comprising a single central conductor.

One advantageous application is motor-vehicle connections.

### BACKGROUND

In the field of connections for transmitting electrical signals and/or data and/or radio-frequency (RF) signals, RF connectors are known that comprise an electrically insulating block in which one or more central contacts are housed, and where appropriated pre-mounted, each being crimped or intended to be crimped around a stripped end of one electrical cable wire.

A coaxial connector sub-assembly 1 of this type is illustrated in FIG. 1.

The sub-assembly 1 comprises a one-piece metal body 10 produced by cutting and rolling, forming an electromagnetic shielding body.

This shielding body 10 holds within it an electrically insulating block into which is inserted a central contact comprising a crimping end part which extends, protruding as it does, towards the rear of the insulating block.

This end part of the central contact is crimped around a stripped end of the wire core 21 of a coaxial electrical cable 2 which may comprise a metal braid 23 for electromagnetic shielding encircling the insulated conductor.

An electrically insulating sheath 24 may directly encircle the core 21 of the wire.

In addition to crimping the central contact, it is known to join such a connector to another part of the cable, such as its metal braid 23, by crimping an outer body forming an electrical ground of the connector around said part.

The crimping force has a direct influence on the mechanical holding force between connector and cable.

However, crimping causes a corresponding deformation of the cable and/or one or more components of the connector. This deformation may potentially have a detrimental effect on the electrical properties of the assembly formed, consisting of the connector crimped onto the cable.

Thus, it is generally necessary to find a compromise between a sufficient mechanical holding force and good electrical properties, such as the characteristic impedance of the transmission line formed by the connector.

Such a compromise may be difficult or even impossible to achieve, in particular in applications where the signals are at high frequency.

To improve the situation, it has already been proposed to insert a bushing, also called a ferrule 16, between the crimping part of the outer ground body of the connector and the part of the cable around which it is intended to be arranged, as shown in FIG. 1.

This ferrule is thus first crimped onto a stripped part of the outer sheath of the cable, in particular onto the metal braid, and then at least one crimping part of the outer ground body of the connector is in turn crimped onto the ferrule.

The major drawback of known solutions involving insertion of a crimping ferrule is that de facto they require demanding crimping forces.

Specifically, crimping the ferrule too tightly onto the cable induces a deformation of the cable and therefore a degradation of the electrical impedance and/or performance in respect of signal transmission, in particular at high frequency. Conversely, with the goal of preserving performance in respect of signal transmission, crimping the ferrule too loosely runs the risk of the ferrule slipping over the metal braid during insertion into the outer ground body.

Furthermore, crimping the outer ground body onto the ferrule may also fail to prevent a risk of translational and/or rotational slippage between the ferrule and the crimped zone of the outer body, in the event of mechanical stresses being applied to the cable. The robustness of the attachment of the cable to the connector, and the electrical continuity between the conductive parts of the cable and connector may also be called into question.

Patent U.S. Pat. No. 10,468,786B2 discloses a connector with a crimping ferrule which has several major drawbacks. This ferrule, referenced 200, first of all requires production of locking projections, referenced 240. In addition, the components must be assembled just right: alignment of the locking tongues, referenced 440, of the outer ground body with the projections 240 requires a high angular precision. Lastly, the crimping jaws used for crimping must have specific shapes with zones that must not physically interfere with the projections. This makes it impossible to press the ferrule evenly, in order to crimp it. This also complicates the angular positioning of the crimping jaws with respect to the ferrule 200, as it must be such as to not crush the projections 240.

There is therefore a need to further improve connectors incorporating a ferrule for crimping onto a cable, in their outer ground body, in particular in order to achieve axial and/or rotational blockage of the ferrule with respect to the cable and the ground body, the obtained connector needing to be reliable and simple to produce, and to not impair electrical performance in respect of transmission of signals, in particular RF signals, through the connector and the cable to which it is connected.

The invention aims to partially or fully meet this need.

### SUMMARY OF THE INVENTION

To this end, the subject of the invention, according to one of its aspects, is a connector sub-assembly, intended to be electrically connected to an electrical cable comprising at least one insulated wire comprising a core and an electrically insulating sheath, a metal braid encircling the at least one insulated wire, and an outer sheath made of electrically insulating material encircling the metal braid;

the sub-assembly extending along a longitudinal axis (X) and comprising:
at least one central contact, intended to be connected, and preferably crimped, to the stripped end of the cable wire,
an electrically insulating block comprising at least one cavity into which the one or more central contacts are intended to be plugged,
an electrically conductive body, comprising:
   a front part defining a recess for housing and holding the electrically insulating block,
   a rear part comprising at least one crimping zone provided internally with at least one protrusion,
a ferrule, intended to be crimped around the end of the metal braid stripped of the outer cable sheath, comprising at least one through-opening configured to house the one or more protrusions, when the rear part of the shielding body is crimped, so as to form an axial abutment between the ferrule and the shielding body, the ferrule further being configured to allow axial abutment of the ferrule against the end of the outer cable sheath, when the ferrule is crimped around the end of the metal braid, prior to crimping the rear part of the shielding body onto the ferrule.

Advantageously, the shielding body is one piece.

Also advantageously, the through-opening of the ferrule is configured to form a rotational abutment between the ferrule and the shielding body.

According to a first embodiment, the ferrule is of hollow partially cylindrical general shape with a cylindrical solid-walled front portion, a central portion which lies in the extension of the front portion around only part of the periphery of the cylinder, forming an offset face, and which comprises the at least one through-opening and a solid-walled rear portion which lies in the extension of the central portion around only part of the periphery of the cylinder and which is intended to effect the axial abutment of the ferrule, against the end of the outer cable sheath, when the ferrule is crimped around the end of the metal braid.

According to a second embodiment, the ferrule is of hollow cylindrical general shape with a cylindrical solid-walled front portion, a cylindrical central portion which lies in the extension of the front portion and which comprises the at least one through-opening and a cylindrical solid-walled rear portion which lies in the extension of the central portion and which is intended to effect the axial abutment of the ferrule, against the end of the outer cable sheath, when the ferrule is crimped around the end of the metal braid.

According to this second embodiment, and according to one advantageous variant of embodiment:
the ferrule comprises two or three through-openings distributed angularly around the periphery of the cylinder;
the rear part of the shielding body comprises two or three protrusions distributed angularly and each configured to be housed in one through-opening.

Preferably, the ferrule is rolled on itself to be crimped around the end of the metal braid.

According to one advantageous variant of embodiment, the rear part of the shielding body comprises two crimping zones, one of which is provided internally with at least the protrusion and the other of which, at the rear, is provided internally with at least one barb configured to catch on the outer sheath of the cable, when the rear part of the shielding body is crimped.

Preferably, the one or more protrusions and where appropriate the one or more barbs are each formed by stamping the rear part of the shielding body.

Also preferably, the shielding body and the ferrule are produced by cutting and rolling.

According to another advantageous embodiment, the sub-assembly comprises two central contacts the rear part of which is intended to be crimped around the conductive core of a wire stripped at its end, the insulating block comprising two cavities parallel to each other, in each of which one of the two central contacts is plugged, and a protrusion projecting longitudinally at the rear and configured to guide each of the two central contacts each crimped onto the conductive core of one stripped wire during plugging in. The rear protrusion of the insulating block therefore make it easier to plug in the central contacts already individually crimped onto one electrical wire.

The invention also relates to a connector, comprising:
at least one sub-assembly as described above,
a housing in which the sub-assembly is housed and secured.

The invention also relates to a ferrule, intended to be crimped around the end of the metal braid stripped of the outer cable sheath, of hollow cylindrical general shape with a cylindrical solid-walled front portion, a cylindrical central portion which lies in the extension of the front portion and which comprises the at least one through-opening and a cylindrical solid-walled rear portion which lies in the extension of the central portion and which is intended to effect the axial abutment of the ferrule, against the end of the outer cable sheath, when the ferrule is crimped around the end of the metal braid.

The invention also relates to a ferrule, intended to be crimped around the end of the metal braid stripped of the outer cable sheath, of hollow partially cylindrical general shape with a cylindrical solid-walled front portion, a central portion which lies in the extension of the front portion around only part of the periphery of the cylinder, forming an offset face, and which comprises the at least one through-opening and a solid-walled rear portion which lies in the extension of the central portion around only part of the periphery of the cylinder and which is intended to effect the axial abutment of the ferrule, against the end of the outer cable sheath, when the ferrule is crimped around the end of the metal braid.

The invention lastly relates to a method for joining a connector sub-assembly as described above to an electrical cable comprising at least one insulated wire comprising a conductive core and an electrical insulating sheath, a metal braid encircling the at least one insulated wire, and an outer sheath of electrically insulating material encircling the metal braid, the method comprising the following steps:
i/ mounting the electrically insulating block in its recess, i.e. the recess provided for this purpose in the shielding body;
ii/ crimping the ferrule onto the metal braid with axial abutment of a rear face of the ferrule against the front end of the outer sheath of the cable and folding the front end of the braid onto the ferrule;
iii/ stripping the end of the one or more wires of the cable to reveal its electrically conductive core and crimping the one or more central contacts onto the one or more electrical wires of the electrical cable;
iv/ plugging the one or more wired central contacts into their housing cavity, i.e. the housing cavity provided for this purpose in the insulating block, preferably under guidance by a protrusion at the rear of the insulating block, and inserting the ferrule crimped onto the cable into the rear crimping part of the ground body;
v/ crimping the crimping zone of the rear part of the shielding body onto the braid and the ferrule so that each protrusion is housed in a through-opening of the ferrule in order to block the ferrule translationally and preferably rotationally with respect to the ground body;
vi/ crimping the crimping zone of the rear part of the shielding body onto the outer sheath of the cable so that each barb catches on, i.e. penetrates into, the sheath in order to block the sheath of the cable translationally and preferably rotationally relative to the ground body,
step ii/ being able to be performed before step i/,
steps v/ and vi/ being able to be carried out simultaneously or sequentially.

Thus, the invention essentially consists of a connector sub-assembly with an electrically insulating block housing one or more central contacts to be crimped to electrical wires of a cable and with an outer shielding body housing a ferrule.

The ferrule is crimped first to the metal braid of the cable in a configuration permitting rear axial abutment against the outer sheath of the cable. In other words, an axial abutment is formed between the rear end of the ferrule and the front end of the outer sheath of the cable.

Once the ferrule has been crimped onto the braid, and the front end of the braid has been folded down onto the outer face of the ferrule, the one or more crimping zones of the rear part of the shielding body are crimped at least onto the ferrule.

During the latter crimping, each protrusion arranged internally in the crimping zone becomes housed in one through-opening of the ferrule provided for this purpose.

In the event of a push/pull or twist on the cable, a protrusion is likely to come into axial and/or radial abutment against a front or rear or lateral edge of an opening.

In the context of the invention, a through-opening may consist of a through-window, i.e. an opening which passes right through the ferrule material while being surrounded by the latter, or of the space devoid of material which results from removing material.

Compared with prior-art solutions, retention of the cable in the connector is improved as a result of the limited retraction distance and the increased mechanical tolerance of the braid, and axial slippage of the ferrule in the ground body is reduced.

Thus, the invention has many advantages compared with prior-art connectors, among which mention may be made of:
optimal pre-positioning of the ferrule during its insertion into the ground body, before the latter is crimped onto the ferrule;
possible limitation of axial and/or rotational slippage of the ferrule with respect to the cable and to the ground body;
increase in the retention force achieved by crimping;
absence or at the very least limitation of the risk of severance of the metal braid of the cable;
no impact on the electrical performance in respect of transmission of signals, especially RF signals, through the connector and the cable to which it is connected.

Other advantages and features of the invention will become more clearly apparent on reading the detailed description of examples of implementation of the invention, which is non-limiting and given by way of illustration, with reference to the following figures.

### BRIEF DESCRIPTION OF DRAWINGS

FIG. 1 shows a side view in partial cross section of one example of a coaxial connector according to the prior art, the central contact of which is crimped onto an electrical cable wire.

FIG. 2 is an exploded perspective view of a coaxial connector sub-assembly with a central contact according to a first embodiment of the invention and of a cable, in a configuration before the cable has been crimped onto the ferrule and the central contact.

FIG. 3 is the same as FIG. 2 with the exception that it illustrates the coaxial connector in its entirety with its housing.

FIG. 4 is a perspective view of the outer ground body according to the invention with its rear part shown in a form before it is crimped.

FIG. 5 is a longitudinal cross-sectional view of the rear part of the outer ground body shown in FIG. 4.

FIG. 6 is a perspective view showing a blank for producing a crimping ferrule according to the first embodiment of the invention.

FIG. 7 is a perspective view of the ferrule shown in FIG. 6 in its form such that it is once crimped onto the metal braid of the cable.

FIG. 8 is a longitudinal cross-sectional view of the ferrule shown in FIG. 7.

FIG. 9 is a side view in partial cross section of the rear part of the outer ground body of the connector with the cable according to the first embodiment, the ferrule being in its form crimped around the braid of the cable, while the rear part of the outer ground body has not yet been crimped around the ferrule.

FIG. 10 is the same as FIG. 9 with the exception that the rear part of the outer ground body is in its form crimped around the ferrule and the situation is one in which the cable is being pulled rearwards.

FIG. 10A is a cross-sectional view of FIG. 10.

FIG. 11 is the same as FIG. 10 with the exception that the situation is one in which the cable is being twisted.

FIG. 11A is a cross-sectional view of FIG. 11.

FIG. 12 is the same as FIG. 10 with the exception that the situation is one in which the cable is being pushed frontward.

FIG. 13 is a perspective view of a coaxial connector sub-assembly with a central contact according to a second embodiment of the invention and of a cable, in a configuration before the cable has been crimped onto the ferrule and the central contact.

FIG. 14 is a perspective view showing a blank for producing a crimping ferrule according to the second embodiment of the invention.

FIG. 15 is a perspective view of the ferrule shown in FIG. 14 in its form such that it is once crimped onto the metal braid of the cable.

FIG. 16 is a perspective view of the ferrule shown in FIG. 15 comprising only two through-openings.

FIG. 17 is a side view in partial cross section of the rear part of the outer ground body of the connector with the cable according to the second embodiment, the ferrule being in its form crimped around the braid of the cable, while the rear part of the outer ground body has not yet been crimped around the ferrule.

FIG. 18 is the same as FIG. 17 with the exception that the rear part of the outer ground body is in its form crimped around the ferrule.

FIG. 18A is a cross-sectional view of FIG. 18.

FIG. 19 is an exploded view of a connector sub-assembly with central contacts according to the invention and of a cable, in a configuration in which two central contacts are crimped onto the wires of a cable, the ferrule being in its form uncrimped onto the metal braid of the cable.

FIG. 20 is a side view in partial cross section of the rear part of the outer ground body of the connector with the cable of the sub-assembly shown in FIG. 19, the ferrule being in its form crimped around the braid of the cable, while the rear part of the outer ground body has not yet been crimped around the ferrule.

FIG. 21 is the same as FIG. 20 with the exception that the rear part of the outer ground body is in its form crimped around the ferrule.

### DETAILED DESCRIPTION

Throughout the present patent application, the terms “front” and “rear” are to be understood with respect to the connection face of a connector sub-assembly according to the invention. Thus, the front portion of a connector component is the face intended to be closest to the complementary connector with which the connector is intended to connect. Thus, the front face of the electrically insulating block of the connector is the face intended to make contact with the face of a complementary connector and the front part of a central contact is the part intended to be coupled to a central contact of the complementary connector.

For the sake of clarity, the same reference number has been used to designate a given element of a prior-art sub-assembly and of a sub-assembly according to the invention.

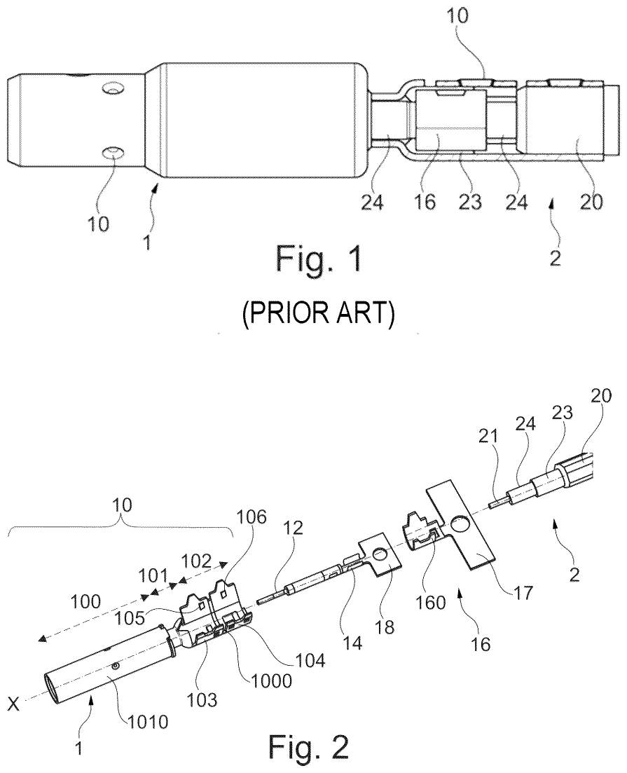

FIG. 1 has already been described in detail in the preamble. It will therefore not be commented on below.

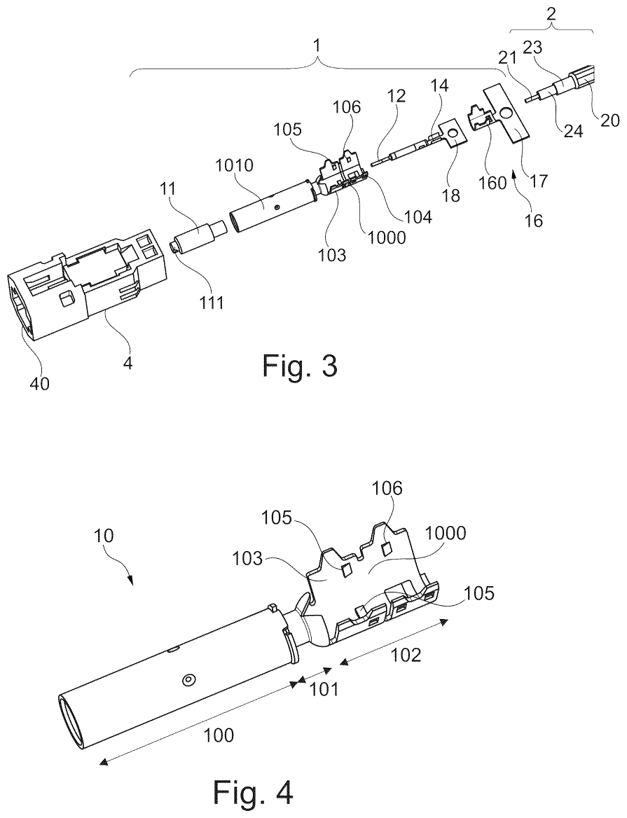

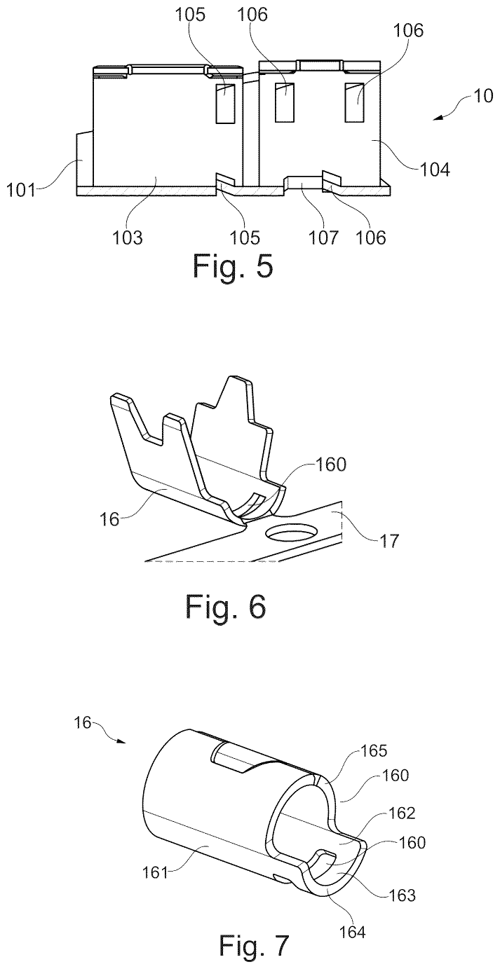

FIGS. 2 and 3 show a sub-assembly 1 of a coaxial connector according to the invention, and a coaxial connector 4 incorporating such a sub-assembly.

The connector sub-assembly 1 extends along a longitudinal axis X, and is pre-mounted, because it comprises an electrically insulating block 11 pre-mounted in a metal body, in particular a one-piece body 10 forming an electromagnetic shielding body.

The sub-assembly 1 is connected to and mounted on a coaxial cable 2 with one insulated wire.

The cable 2 comprises an outer sheath 20 made of electrically insulating material, and an electrical conductor 21 insulated from the outside by the outer sheath 20.

The cable 2 also comprises a metal braid 23 for electromagnetic shielding, encircling the insulated conductor.

An electrically insulating sheath 24 is interposed between the core 21 of the insulated conductor and the metal braid 23.

The one-piece metal body 10 forming the electromagnetic shielding body is produced by cutting and rolling, and ensures electrical ground continuity and impedance matching.

The metal body 10 may in particular comprise a metal jacket 1000 and, where appropriate, a protective tube 1010 assembled at least in part around the jacket 1000.

The metal jacket 1000 is made up of three parts: a front part 100, an intermediate part 101 and a rear part 102, as illustrated in FIGS. 2 to 4.

The front part 100 defines internally a recess in which the electrically insulating block 11 is held.

A central contact 12 is inserted into a cavity 111 of the electrically insulating block 11 provided for this purpose, the central contact comprising a crimping end part 14 which extends, in particular protruding as it does, towards the rear of the insulating block 11. The single central contact 12 may be formed from a one-piece metal blank produced using a cutting and rolling technique, preferably from a continuous strip 18.

The end part 14 of the central contact 12 is crimped around a stripped end of the core 21 of a wire of the coaxial electrical cable 2.

In the example illustrated, the central contact 12 is of male type.

The intermediate part 101 of the shielding body 10 is narrowed. This narrowed part 101 makes it possible to match the impedance of the rear part of the sub-assembly 1, where the cable 2 is crimped, preferably under a shielding braid, and of the front part comprising the insulating block 11 into which the central contact 12 is plugged.

The rear part 102 of the shielding body 10 comprises two crimping zones 103, 104, one in the rear extension of the other.

The crimping zone 103 comprises internally one or more inwardly projecting protrusions 105.

The crimping zone 104 comprises internally one or more inwardly projecting barbs 106. The protrusions 105 and barbs 106 may be produced by stamping, preferably simultaneously, and may have, where appropriate, the same shape and/or the same dimensions. The protrusions 105 and barbs 106 may take any form allowing a mechanical abutment to be achieved.

The sub-assembly 1 further comprises a crimping ferrule 16 which comprises a through-opening 160 in it.

As illustrated in FIG. 2, the ferrule 16 may be formed from a one-piece metal blank produced using a cutting and rolling technique, preferably from a continuous strip 17.

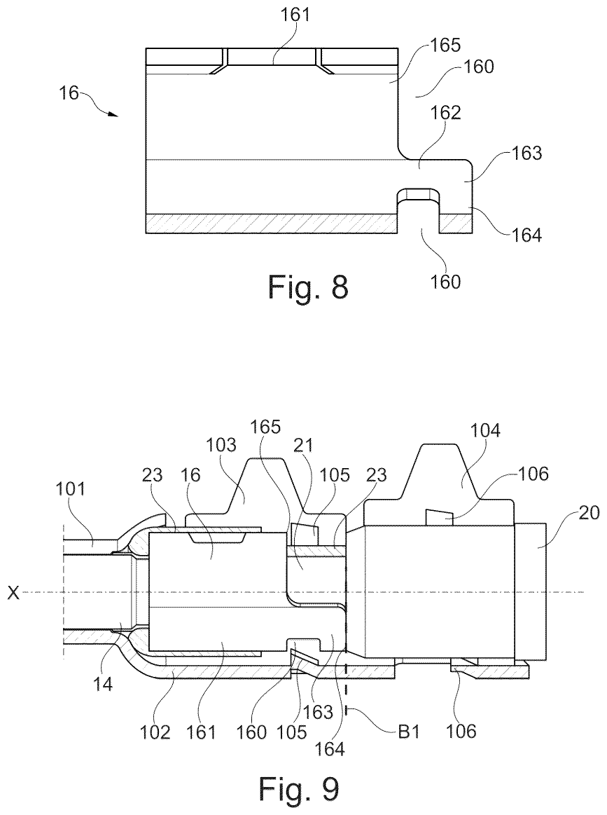

In its crimped configuration, shown in FIGS. 7 and 8, the ferrule 16 is of hollow partially cylindrical general shape with a cylindrical solid-walled front portion 161, a central portion 162 which lies in the extension of the front portion around only part of the periphery of the cylinder and which comprises the through-opening 160 and a solid-walled rear portion 163 which lies in the extension of the central portion around only part of the periphery of the cylinder.

This rear portion 163 is intended to effect, via its rear face 164, the axial abutment of the ferrule against the end of the outer cable sheath.

The rear face 164 may optionally comprise a fastener, left over from cutting the ferrule from the continuous strip 17. This fastener has a thickness from the rear face 164 of 0 to 0.3 mm.

The rear face 165 of the cylindrical front portion 161 is a face that is longitudinally offset, frontwards, from the rear face 164 of the rear portion 163. This offset face 165 makes it possible to obtain an indentation, forming a through-opening 160, facilitating angular orientation of the ferrule in the rear part of the body, and thereby limiting the risk of interference between protrusions of the ground body and ferrule during joining and crimping.

A sub-assembly 1 as has just been described is housed and fastened in the recess 40 of a suitable housing 4 as shown in FIG. 3, with the central contact 12 already crimped, via its crimping part 14, to the stripped end of the wire 21 of the cable 2.

In order to assemble a sub-assembly 1 as has just been described to a cable 2, the following steps are carried out.

It will be noted that, beforehand, the outer sheath 20 of an electrical cable 2 is stripped to reveal the metal braid 23 over a predetermined distance.

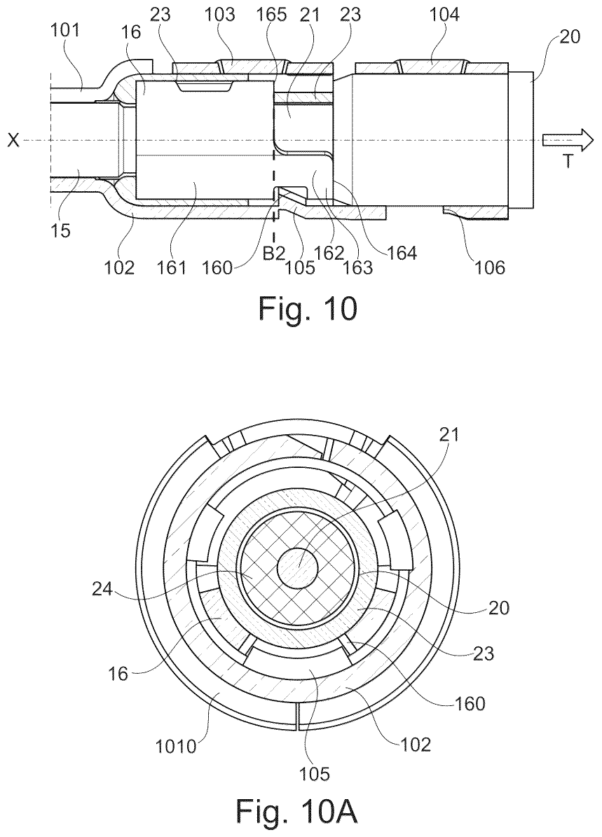

The joining steps are as follows:
i/ mounting the electrically insulating block 11 in its recess, i.e. the recess provided for this purpose in the metal jacket 1000, and, where appropriate, assembling the protective tube 1010 with the metal jacket;
ii/ crimping the ferrule 16 onto the metal braid 23 with axial abutment B1 of the rear face 164 of the rear portion 163 of the ferrule 16 against the front end of the outer sheath 20 of the cable 2 (FIG. 9). The front end of the braid is then folded over the outer face of the ferrule;
iii/ stripping the end of the wire 21 of the cable 2 to reveal its electrically conductive core and crimping the central contact 12 onto the electrical wire 21 of the electrical cable 2;
iv/ plugging the wired central contact 12 into its housing cavity 111, i.e. the housing cavity provided for this purpose in the insulating block 11, and inserting the ferrule 16 crimped onto the cable into the rear crimping part of the ground body;
v/ crimping the crimping zone 103 of the rear part 102 of the shielding body onto the braid and the ferrule 16 so that each protrusion 105 is housed in a through-opening 160 of the ferrule (FIG. 10), in order to block the ferrule translationally and rotationally with respect to the ground body;
vi/ crimping the crimping zone 104 of the rear part 102 of the shielding body onto the outer sheath 20 of the cable 2 so that each barb 106 catches on, i.e. penetrates into, the sheath 20 (FIG. 10), in order to block the sheath of the cable translationally and rotationally relative to the ground body.

Step ii/ may be carried out before step i/.

Steps v/ and vi/ may be carried out simultaneously or sequentially.

Step ii/ makes it possible to achieve satisfactory crimping while blocking the ferrule 16 in the rearwards direction against the end of the outer sheath of the cable. This abutment makes it possible to maintain correct positioning of the ferrule relative to the ground body, before the rear part of the latter is crimped onto the braid and the ferrule.

The crimping of the obtained assembly is better than the crimping of prior-art solutions, even in the case where the cable is subjected to mechanical stresses.

Thus, should the cable 2 be pulled in the rearwards direction, as illustrated by the arrow T in FIG. 10, the front edge of the through-opening 160 and/or the rear edge of the front portion 161 come(s) into axial abutment B2 against the front face of the protrusions 105. In other words, by virtue of this axial abutment B2, the retraction distance of the cable 2 is limited and the retention force of the cable is increased.

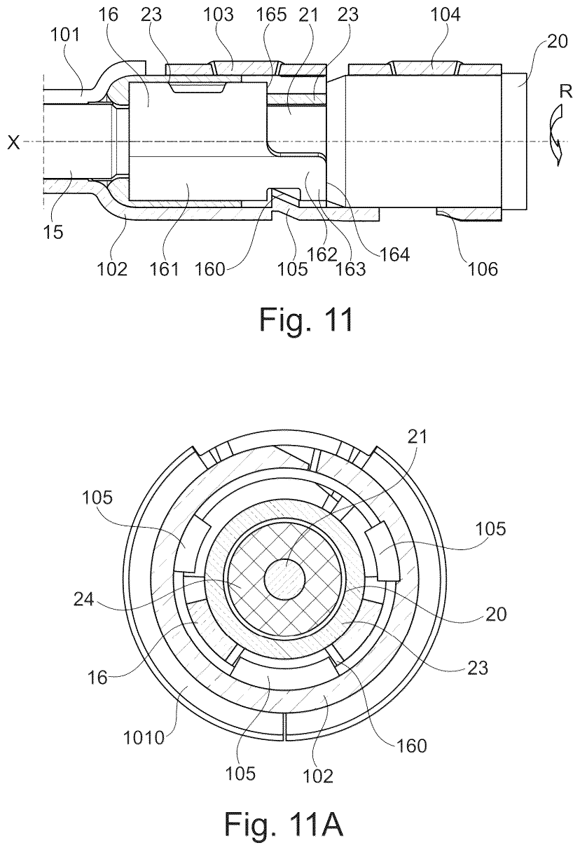

Should the cable 2 be twisted, as illustrated by the arrow R in FIG. 11, a lateral edge of the through-opening 160 and/or a lateral edge of the central portion 162 come(s) into radial abutment against the lateral faces of the protrusions 105. In other words, by virtue of this radial abutment, rotational slippage of the ferrule 16 in the ground body 10 is limited and the mechanical tolerance of the strands of the braid 23 is improved because complete severance of the strands is avoided even should the cable 2 be twisted violently.

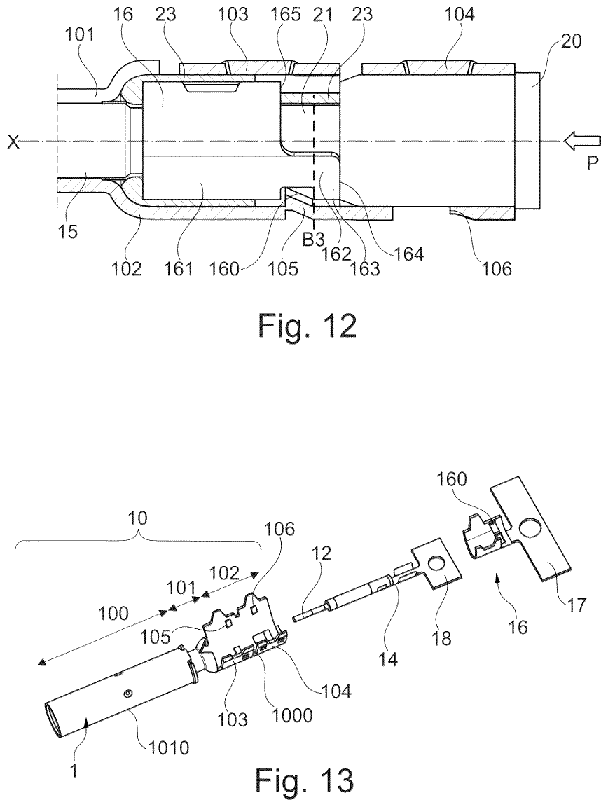

Should the cable 2 be pushed in the forwards direction, as illustrated by the arrow P in FIG. 12, the rear face of the protrusions 105 comes into axial abutment B3 against the rear edge of the through-opening 160 defined in the rear portion 163.

In other words, by virtue of this axial abutment B3, axial slippage of the ferrule translationally in the ground body 10 is limited.

This configuration therefore makes it possible to prevent forces on the cable from being transmitted to the connector and to its interface with the complementary connector.

In other words, the obtained assembly makes it possible to limit the relative translational and/or rotational movement between the ferrule 16 and the ground body 10, thus reducing the risk of severance of the braid and of severance of the connection between the cable and the connector.

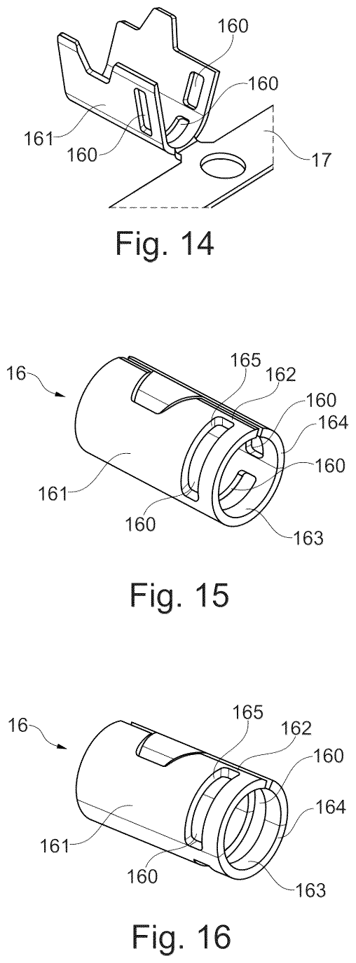

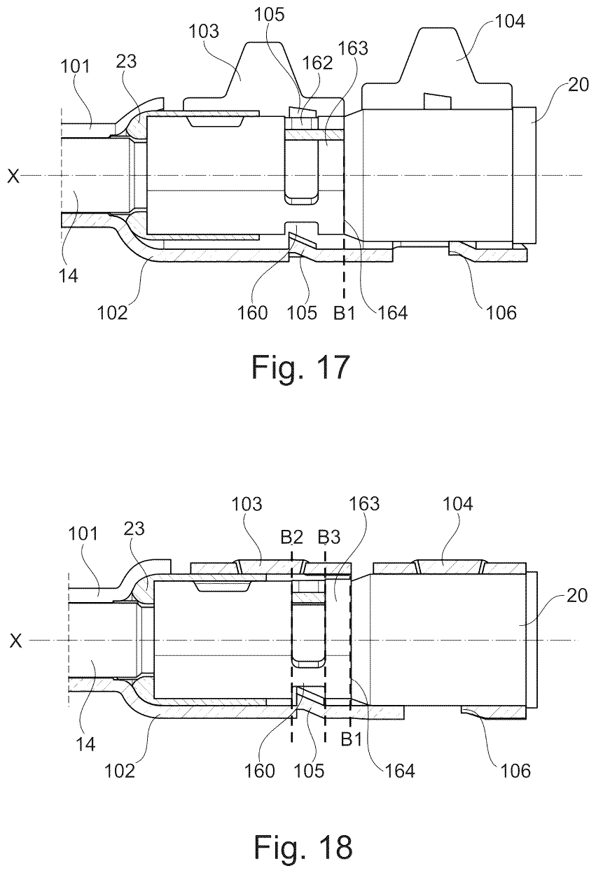

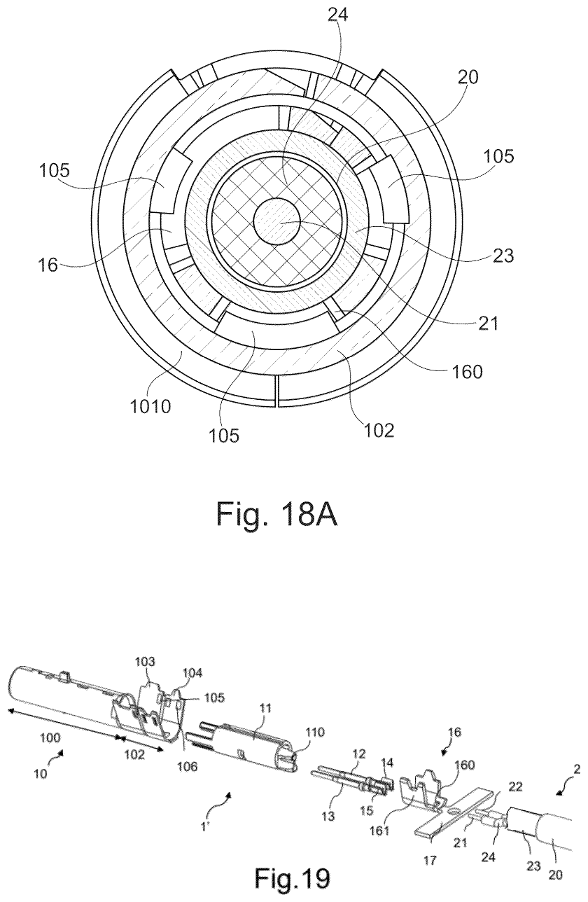

FIGS. 13 to 18A illustrate a second embodiment in which only the ferrule 16 has a structure different from the one described above.

In FIGS. 13 to 18A, the ferrule 16 is of hollow cylindrical general shape with a solid-walled cylindrical front portion 161, a cylindrical central portion 162 which lies in the extension of the front portion and which comprises the through-opening 160 and a solid-walled cylindrical rear portion 163 which lies in the extension of the central portion.

As illustrated in FIG. 15, the ferrule 16 preferably comprises three through-openings 160 distributed angularly at approximately 120° from one another, each intended to house one protrusion 105.

Alternatively, as shown in FIG. 16, the ferrule 16 may comprise only two through-openings, with an angular distribution tailored to the position of the protrusions 105 on the ground body. The reduction in the number of openings allows a greater tolerance in respect of the angular position about the axis X of the ferrule in the ground body.

The rear portion 163, which extends all the way around the cylindrical periphery of the ferrule 16, makes it possible to optimise the area of the ferrule in abutment against the front end of the sheath 20 of the cable.

Other variants and improvements may be provided without however departing from the scope of the invention.

Although, in the illustrated examples, the coaxial connector sub-assembly was configured to have a single central contact 12 plugged into one housing cavity 111, the invention may be implemented in the case where two central contacts are to be plugged into two cavities running parallel to each other, or in the case where there are a number greater than two of central contacts to be plugged into the same electrically insulating block.

Such a connector sub-assembly l′ with two central contacts 12, 13 and one ferrule 16 crimped around the end of the metal braid 23 stripped of the outer sheath 20 of a cable 2 is illustrated in FIGS. 19 to 21.

The rear part 14, 15 of the contacts 12, 13 is crimped around the conductive core 21, 22 of a wire of the cable 2, stripped at its end.

Each of the two contacts 12, 13 is plugged into one of the two mutually parallel cavities of an insulating block 11.

As may be seen in FIG. 19, the insulating block 11 comprises a protrusion 110 projecting longitudinally at the rear and configured to guide each of the two central contacts 12, 13 as it is plugged in. Thus, this rear protrusion 110 makes it easier to plug in central contacts 12, 13 already crimped individually to the electrical wire.

In FIG. 20, the assembly formed from the electrically insulating block 11 and the contacts 12 and 13 crimped onto the core 21 and 22 of the cable 2 is in the inserted position in the recess of the ground body 10. The braid 23 has been folded back over the crimped ferrule 16. In other words, the braid 23 first passes through the interior of the crimped ferrule 16, then passes over the exterior of the crimped ferrule 16.

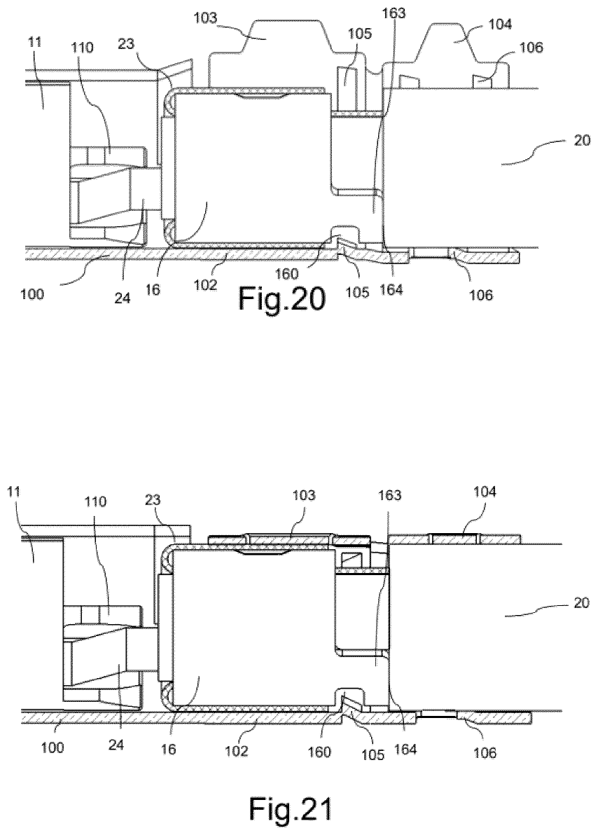

In FIG. 21, the crimping zones 103, 104 of the ground body 10 have been respectively crimped onto the braid 23 and ferrule 16, on the one hand, and onto the outer sheath 20 of the cable 2, on the other hand. After the zone 103 has been crimped, the protrusion 105 is positioned in the through-opening 160, which is either a window in the ferrule or an indentation. Furthermore, after the zone 104 has been crimped, the barb 106 will have penetrated into the sheath 20.

In the case of an embodiment with two central contacts, the electrical cable comprises two insulated wires, each insulated wire comprising a conductive core 21 encircled by an electrically insulating sheath 24, the two insulated wires being encircled by a metal braid 23. The metal braid may be encircled by an outer insulating sheath.

The shape and/or dimensions of the protrusions 105 may differ from those illustrated and indeed the protrusions may take any form. They may for example take the form of a right parallelepiped or a curved protuberance, inter alia.

1. A connector sub-assembly or a connector, intended to be electrically connected to an electrical cable comprising at least one insulated wire comprising a core and an electrically insulating sheath, a metal braid encircling the at least one insulated wire, and an outer sheath made of electrically insulating material encircling the metal braid;
the sub-assembly extending along a longitudinal axis (X) and comprising:
at least one central contact, intended to be connected, to the stripped end of the cable wire,
an electrically insulating block comprising at least one cavity into which the one or more central contacts are intended to be plugged,
an electrically conductive body forming a shielding body, comprising:
a front part defining a recess for housing and holding the electrically insulating block,
a rear part comprising at least one crimping zone provided internally with at least one protrusion,
a ferrule, intended to be crimped around the end of the metal braid stripped of the outer cable sheath, comprising at least one through-opening configured to house the one or more protrusions, when the rear part of the shielding body is crimped, so as to form an axial abutment between the ferrule and the shielding body, the ferrule further being configured to allow axial abutment of the ferrule against the end of the outer cable sheath, when the ferrule is crimped around the end of the metal braid, prior to crimping the rear part of the shielding body onto the ferrule.

2. The sub-assembly according to claim 1, wherein the shielding body is one piece.

3. The sub-assembly according to claim 1, wherein the through-opening of the ferrule is configured to form a rotational abutment between the ferrule and the shielding body.

4. The sub-assembly according to claim 1, wherein the ferrule is of hollow partially cylindrical general shape with a cylindrical solid-walled front portion, a central portion which lies in the extension of the front portion around only part of the periphery of the cylinder, forming an offset face, and which comprises the at least one through-opening and a solid-walled rear portion which lies in the extension of the central portion around only part of the periphery of the cylinder and which is intended to effect the axial abutment of the ferrule, against the end of the outer cable sheath, when the ferrule is crimped around the end of the metal braid.

5. The sub-assembly according to claim 1, wherein the ferrule is of hollow cylindrical general shape with a cylindrical solid-walled front portion, a cylindrical central portion which lies in the extension of the front portion and which comprises the at least one through-opening and a cylindrical solid-walled rear portion which lies in the extension of the central portion and which is intended to effect the axial abutment of the ferrule, against the end of the outer cable sheath, when the ferrule is crimped around the end of the metal braid.

6. The sub-assembly according to claim 5, wherein:
the ferrule comprises two or three through-openings distributed angularly around the periphery of the cylinder;
the rear part of the shielding body comprises two or three protrusions distributed angularly and each configured to be housed in one through-opening.

7. The sub-assembly according to claim 1, wherein the ferrule is rolled on itself to be crimped around the end of the metal braid.

8. The sub-assembly according to claim 1, wherein the rear part of the shielding body comprises two crimping zones, one of which is provided internally with at least the protrusion and the other of which, at the rear, is provided internally with at least one barb configured to catch on the outer sheath of the cable, when the rear part of the shielding body is crimped.

9. The sub-assembly according to claim 1, wherein the one or more protrusions and where appropriate the one or more barbs are each formed by stamping the rear part of the shielding body.

10. The sub-assembly according to claim 1, wherein the shielding body and the ferrule are produced by cutting and rolling.

11. A connector comprising:
assembly according to any claim 1,
a housing in which the sub-assembly is housed and secured.

12. A ferrule, intended to be crimped around the end of the metal braid stripped of the outer cable sheath, of hollow cylindrical general shape with a cylindrical solid-walled front portion, a cylindrical central portion which lies in the extension of the front portion and which comprises the at least one through-opening and a cylindrical solid-walled rear portion which lies in the extension of the central portion and which is intended to effect the axial abutment of the ferrule, against the end of the outer cable sheath, when the ferrule is crimped around the end of the metal braid.

13. A ferrule, intended to be crimped around the end of the metal braid stripped of the outer cable sheath, of hollow partially cylindrical general shape with a cylindrical solid-walled front portion, a central portion which lies in the extension of the front portion around only part of the periphery of the cylinder, forming an offset face, and which comprises the at least one through-opening and a solid-walled rear portion which lies in the extension of the central portion around only part of the periphery of the cylinder and which is intended to effect the axial abutment of the ferrule, against the end of the outer cable sheath, when the ferrule is crimped around the end of the metal braid.

14. A method for joining a connector sub-assembly according to claim 1 to an electrical cable comprising at least one insulated wire comprising a conductive core and an electrical insulating sheath, a metal braid encircling the at least one insulated wire, and an outer sheath of electrically insulating material encircling the metal braid, the method comprising the following steps:
i. mounting the electrically insulating block in its recess, i.e. the recess provided for this purpose in the shielding body;
ii. crimping the ferrule onto the metal braid with axial abutment (B1) of a rear face of the ferrule against the front end of the outer sheath of the cable and folding the front end of the braid onto the ferrule;
iii. stripping the end of the one or more wires of the cable to reveal its electrically conductive core and crimping the one or more central contacts onto the one or more electrical wires of the electrical cable;
iv. plugging the one or more wired central contacts into their housing cavity, i.e. the housing cavity provided for this purpose in the insulating block, and inserting the ferrule crimped onto the cable into the rear crimping part of the ground body;
V. crimping the crimping zone of the rear part of the shielding body onto the braid and the ferrule so that each protrusion is housed in a through-opening of the ferrule in order to block the ferrule translationally with respect to the ground body;
vi. crimping the crimping zone of the rear part of the shielding body onto the outer sheath of the cable so that each barb catches on, i.e. penetrates into, the sheath in order to block the sheath of the cable translationally relative to the ground body,
step ii. being able to be performed before step i.
